(19) United States
(12) Patent Application Publication
(10) Pub. No.: US 2019/0047426 A1
(43) Pub. Date: Feb. 14, 2019

(54) ELECTROMOBILITY CHARGE INTERFACE SOCKET AND MODULAR CLOSURE DEVICE

(71) Applicant: Phoenix Contact E-Mobility GmbH, Schieder-Schwalenberg (DE)

(72) Inventors: Frederik Effenberger, Detmold (DE); Dong Jianjun, Wuxi (CN)

(21) Appl. No.: 15/763,450

(22) PCT Filed: Sep. 29, 2016
(86) PCT No.: PCT/EP2016/073207

§ 371 Date: Mar. 27, 2018

(30) Foreign Application Priority Data
Oct. 1, 2015 (DE) 10 2015 116 649.6

(51) Int. Cl. B60L 11/18; H01R 13/73; H01R 13/447; H01R 13/627

(52) U.S. Cl. CPC B60L 11/1818; H01R 13/73; H01R 2201/26; H01R 13/6272; B60L 2230/12; H01R 13/447

(57) ABSTRACT

An electromobility charging interface socket for connecting an electromobility charging station to an electromobility vehicle includes: a socket housing including a front panel having a connector-face receiving opening and a rear face having a power outlet; an inner part that is arranged in the power outlet and includes a connector face having a plurality of electrical contacts; a collar that is arranged on the front panel of the socket housing, surrounds the connector-face receiving opening, and projects from the front panel; mounting holes arranged on the front panel of the socket housing beside the connector-face receiving opening, by which holes the electromobility charging interface socket can be mounted on the electromobility charging station; and a closure device that is arranged on the front panel of the socket housing and is separate from the socket housing. The closure device includes a bearing holder.

### CROSS-REFERENCE TO PRIOR APPLICATIONS

This application is a U.S. National Phase application under 35 U.S.C. § 371 of International Application No. PCT/EP2016/073207, filed on Sep. 29, 2016, and claims benefit to German Patent Application No. DE 10 2015 116 649.6, filed on Oct. 1, 2015. The International Application was published in German on Apr. 6, 2017 as WO 2017/055410 under PCT Article 21(2).

### FIELD

The invention relates to an electromobility charging interface socket for connecting an electromobility charging station to an electromobility vehicle, and to a modular closure device for an electromobility charging interface socket.

### BACKGROUND

The market for electromobility, i.e. means of transport such as vehicles that are driven by electricity alone or are assisted thereby, is growing constantly. As a consequence, the need for charging stations for charging the energy accumulators of said vehicles is also growing.

Now, the charging technology has become standardized worldwide to a small number of forms, such that a user can usually manage with one cable or a few cables and can use the growing network of charging stations.

Charging stations are usually exposed to the weather and environmental conditions. The market for charging sockets for a charging station of this type therefore essentially offers charging sockets that comprise a flap cover integrated into the charging socket. In other words, known charging sockets typically have a cover mounting that is integrally connected to the charging socket, and is in particular injection-molded together with the charging socket.

For the operator of a charging station, in this case it is currently not possible to select whether or not the charging socket on the charging station should be able to be closed by a cover. In particular, the operator of the charging station cannot retrofit a cover to a charging socket without a cover or reversibly remove the cover subsequently, i.e. without forcibly removing or breaking off the cover.

Manufacturers of charging sockets of this type would in turn have to construct, approve and standardize their own charging interface without a cover for the cases in which an operator wants to purchase a charging interface without a flap cover, in order to also satisfy these customers that do not want a flap cover. The two charging sockets would then have to be sold and stored in warehouses in parallel, resulting in higher storage and operating costs.

### SUMMARY

In an embodiment, the present invention provides an electromobility charging interface socket for connecting an electromobility charging station to an electromobility vehicle, comprising: a socket housing comprising a front panel having a connector-face receiving opening and a rear face having a power outlet; an inner part that is arranged in the power outlet and comprises a connector face having a plurality of electrical contacts; a collar that is arranged on the front panel of the socket housing, surrounds the connector-face receiving opening, and projects from the front panel; mounting holes arranged on the front panel of the socket housing beside the connector-face receiving opening, by which holes the electromobility charging interface socket is configured to be mounted on the electromobility charging station; and a closure device that is arranged on the front panel of the socket housing and is separate from the socket housing, wherein the closure device comprises a bearing holder, wherein the bearing holder of the closure device comprises a base portion extending along the front panel and in parallel with the front panel, two holder mounting holes arranged in the base portion for detachably mounting the bearing holder on the socket housing, a mounting tab arranged on the base portion, and a bearing supported in the mounting tab for supporting a cover, and wherein the two holder mounting holes are arranged so as to line up with two of the mounting holes on the socket housing, such that the holder mounting holes overlap with the mounting holes when the bearing holder is arranged on the front panel and beside the connector-face receiving opening.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a first embodiment of an EM charging interface socket having the bearing holder and cover attached on the left,

FIG. 2 shows another embodiment of the EM charging interface socket with the cover closed,

FIG. 3 shows an embodiment of the EM charging interface socket having the bearing holder and cover attached on the right,

FIG. 4 shows an embodiment of the EM charging interface socket having the bearing holder and cover attached at the bottom,

FIG. 5 shows an embodiment of the EM charging interface socket having the bearing holder and cover attached at the top,

FIG. 6 shows an embodiment of an EM charging plug,

FIG. 7 shows an embodiment of the EM charging interface socket coupled to the EM charging plug,

FIG. 8 shows another embodiment of the EM charging interface socket coupled to the EM charging plug, with the bearing holder and cover at the top,

FIG. 9 shows an embodiment of the EM charging interface socket having the bearing holder on the left and the latch holder on the right,

FIG. 10 shows the embodiment from FIG. 9 with the cover closed,

FIG. 11 shows an embodiment of the EM charging interface socket having the bearing holder and cover on the right and the latch holder on the left,

FIG. 12 shows an embodiment of the EM charging interface socket having the bearing holder and cover at the bottom and the latch holder at the top,

FIG. 13 shows an embodiment of the EM charging interface socket having the bearing holder and cover at the top and the latch holder at the bottom,

FIG. 14 shows an embodiment of the EM charging interface socket having the cover on the left and the latch holder on the right,

FIG. 15 shows an embodiment of the EM charging interface socket with the EM charging plug inserted and the bearing holder and cover at the top,

FIG. 16 shows an embodiment of the EM charging interface socket with the EM charging plug inserted and the bearing holder and cover on the left,

FIG. 17 is a partial sectional side view of an embodiment of the EM charging interface socket having the bearing holder and cover at the top,

FIG. 18 is a sectional view of a detail of an embodiment of the EM charging interface socket,

FIG. 19 shows another embodiment of the EM charging interface socket, with an unsuitable EM charging plug inserted,

FIG. 20 is a sectional view of a detail of the embodiment from FIG. 19,

FIG. 21 shows an embodiment of the EM charging interface socket with the bearing holder on the left without the cover for a better view into the bearing holder,

FIG. 22 shows an EM charging interface socket screwed to a charging station,

FIG. 23 is a rear view of an EM charging interface socket screwed to a charging station,

FIG. 24 shows an assembly of an EM charging interface socket screwed to a charging station, an EM charging plug that can be inserted therein and an EM vehicle to be charged,

FIG. 25 shows another assembly of an EM charging interface socket arranged on a charging station, an EM charging plug that can be inserted therein and an EM vehicle to be charged comprising an EM charging interface socket,

FIG. 26 shows yet another assembly of an EM charging interface socket attached to a charging station, an EM charging plug inserted therein and an EM vehicle to be charged.

### DETAILED DESCRIPTION

In an embodiment, the present invention provides a charging interface socket in which the operator of the charging station can reversibly select, at any time, whether the charging interface socket should be closed or can remain open.

In an embodiment, the present invention provides modular electromobility charging interface sockets for a wide range of applications of charging stations, and in the process to use the minimum number of different components or assemblies possible in order to reduce storage and to cut manufacturing and stock costs.

According to an embodiment of the invention, an electromobility (EM) charging interface socket for connecting an electromobility charging station to an electromobility vehicle is provided. The term electromobility vehicle not only covers land vehicles, but can also include electromobility aircraft and electromobility watercraft, for example.

The EM charging interface socket comprises a socket housing comprising a front panel having a connector-face receiving opening and comprising a rear face having a power outlet. The connector-face receiving opening is preferably positioned in the center of the front panel such that the front panel substantially forms a lateral web around the connector-face receiving opening perpendicularly to the connector-face receiving opening.

An inner part comprising a connector face having a plurality of electrical contacts is arranged in the power outlet. The connector face is open towards the front panel, such that contacts of a plug can be connected to the electrical contacts of the connector face. At the rear side in the power outlet, electrical lines can be electrically contacted by the electrical contacts of the connector face, such that the EM charging interface socket is electrically connected in the charging station and the EM vehicle can be charged at the EM charging interface socket.

A collar that projects from the front panel and surrounds the connector-face receiving opening is arranged on the front panel of the socket housing. The collar is in particular integrally formed with the socket housing. Furthermore, the collar may project perpendicularly to the front panel, such that a right angle is formed between the front panel and the collar. The collar in particular forms the edge of the connector-face receiving opening.

Preferably, an electromobility charging plug can be connected to the EM charging interface socket such that it can be plugged into the collar, i.e. can be inserted into the collar or attached to the collar. More preferably, the EM charging plug can additionally or alternatively be latched to the collar, such that the EM charging plug can engage around the collar and/or can engage in the collar and be latched therein.

In one embodiment, the collar surrounding the connector-face receiving opening may comprise a locking hole, preferably on the top thereof, in which a locking pin of the EM charging plug can engage in order to hold the EM charging plug in the EM charging interface socket. For example, the EM charging plug comprising a charging-plug collar may engage in the collar of the EM charging interface socket when the EM charging plug is inserted into the EM charging interface socket, and at the same time, on the outside, may engage in the locking hole from the outside by means of a preferably actuatable latching hook, in order to establish a rigid and possibly temporarily non-detachable connection between the EM charging plug and the EM charging interface socket. In a more preferred embodiment, the latching hook may even be released or locked electromechanically or by an electromagnet controlled by software, such that a charging program can finish completely before the user can remove the EM charging plug from the EM charging interface socket again.

Mounting holes are arranged on the front panel of the socket housing beside the connector-face receiving opening, by means of which holes the electromobility charging interface socket can be mounted on the electromobility charging station. In other words, mounting holes, for example screw holes or insertion sleeves, are arranged around the connector-face receiving opening, through which holes or sleeves screws can be inserted that for example can each be screwed into a thread in the EM charging station.

The closure device according to the invention that is separate from the socket housing is arranged on the front panel of the socket housing. In other words, the closure device is a component that is manufactured separately from the socket housing and can be detached from the socket housing. The closure device is in particular attached to the front of the front panel and for example is simultaneously mounted on the EM charging interface socket by the same mounting means which are used to mount the EM charging interface socket on the EM charging station.

The closure device comprises a bearing holder that comprises a base portion extending along the front panel and in parallel with the front panel. For example, the base portion of the bearing holder is a substantially planar portion that is designed to come into direct contact with the front panel beside the connector-face receiving opening. For this purpose, the base portion is kidney-shaped, for example, and therefore it is wider at the two ends than in its central portion. In particular, the base portion of the bearing holder is shaped such that it extends along the collar and follows the rounded shape of the collar.

Two holder mounting holes are arranged in the base portion for detachably mounting the bearing holder on the socket housing. The holder mounting holes are preferably arranged at the ends and/or in a widened portion of the base portion. Furthermore, a peripheral supporting edge of the base portion that has sufficient strength to absorb the pressure when the bearing holder is indirectly mounted on the EM charging station is preferably arranged around the holder mounting holes.

The bearing holder further comprises a mounting tab arranged on the base portion. The mounting tab is preferably arranged between the holder mounting holes. For example, the mounting tab is formed by the bearing holder projecting forwards perpendicularly to the front panel on the top of the base portion. The mounting tab in particular comprises a bearing receiving portion. A bearing for supporting a cover is therefore formed in the mounting tab.

In one embodiment, the bearing holder may comprise two mounting tabs that are preferably arranged beside one another on the base portion. The two mounting tabs may each comprise a bearing receiving portion into which a bearing rod can be pushed, for example. A bearing for supporting the cover is therefore formed in the mounting tabs. In this embodiment, the bearing of the cover is arranged between the two mounting tabs.

The two holder mounting holes are arranged in the base portion such that they can be arranged so as to line up with two of the mounting holes on the socket housing, such that the holder mounting holes overlap with the mounting holes when the bearing holder is arranged on the front panel and beside the connector-face receiving opening.

The EM charging interface socket preferably comprises a plurality of mounting holes arranged on the front panel of the socket housing around the connector-face receiving opening at equal spacing from one another. For example, the front panel may have four sides, each pair of two sides extending symmetrically to one another, such that four corners are formed, and each corner comprises a mounting hole.

If the mounting holes are each at equal spacing from one another, the bearing holder can be selected to be arranged in two adjacent mounting holes on one of the, in particular four, sides of the socket housing, and can be detachably connected to the socket housing. In other words, the bearing holder and thus the cover supported in the bearing holder can be selected to be attached to any side of the EM charging interface socket, and therefore the operator of the charging station can select the orientation of the cover. For example, by selecting the cover position, previously inaccessible positions can now be provided with an EM charging interface socket, for example positions that are very tight and for example are laterally adjacent to another structure. Therefore, an EM charging interface socket that is installed up high can be provided with a closure device according to the invention in which it is conveniently possible for the cover to be opened upwards. By contrast, an EM charging interface socket that is installed in a very low position can comprise a closure device in which the cover is conveniently opened downwards, which is beneficial for the user and thus increases user satisfaction. If the EM charging interface socket is installed in a location in which it is not exposed to any weather conditions, for example, such as in a warehouse or the like, a cover can be completed omitted according to the invention. If it later proves necessary to provide a cover, the closure device can be retrofitted using simple means, in particular without having to replace the entire EM charging interface socket and rewire it in the process.

The cover that is supported in the bearing of the bearing holder closes the connector-face receiving opening when shut. Optionally, the cover comprises a sealing ring or sealing means in order to close the connector-face receiving opening in an air-tight and/or water-tight manner. Preferably, the cover seals the connector-face receiving opening at the collar.

A damper, in particular a spring for slowly opening the cover, may be arranged on the bearing of the bearing holder. In other words, the damper may generate tensile force in the direction of the connector-face receiving opening, which pulls the cover towards the closed state. Advantageously, the EM charging interface socket is thus automatically closed by the cover of the closure device when the user is no longer interacting with it and does not insert an EM charging plug into the EM charging interface socket.

On an inner edge pointing towards the connector-face receiving opening, the bearing holder may comprise a concave portion directed away from the collar. In other words, the bearing holder may be shaped such that it has a straight first side extending in parallel and along the outer edge of the front panel, and a second side, opposite the first side, that faces the connector-face receiving opening and is concave such that the bearing holder tapers in the central region. Particularly advantageously, the tapering of the bearing holder on one side allows a locking pin of the EM charging plug to be guided between the collar and the bearing holder, in particular when the bearing holder is mounted on the top of the EM charging interface socket. A latch receiving portion can then be arranged on or in the collar of the EM charging interface socket, into which receiving portion the locking hook of the EM charging plug engages and latches when the EM charging plug is connected to the EM charging interface socket.

The closure device may also comprise a latch holder arranged opposite the bearing holder, the latch holder comprising a base portion extending along the front panel and in parallel with the front panel, two holder mounting holes arranged in the base portion for detachably mounting the cover holder on the socket housing, two mounting tabs arranged on the base portion and a latch that engages in the two mounting tabs for latching the cover when said cover is closed. The latch holder is preferably arranged on the front panel opposite the bearing holder. When closed, the cover can preferably be latched into the latch, such that the cover is securely held in the closed state.

If the closure device comprises a latch holder by means of which the cover can be securely held in the closed state, the damper can also damp the closing movement of the cover. When the damper damps the closing movement, the cover is pressed against the damper into the latching position, i.e. the closed state, by means of pressure, and when the latching is released the cover automatically and conveniently springs into the open state. The damper can be set such that it automatically holds the cover in the open state until the user has finished using the EM charging interface socket and closes the connector-face receiving opening manually with the cover.

It is also possible to release the latch in a controlled manner electromechanically or by means of a magnet, for example. The retrofittable closure device can therefore simultaneously act as access protection for the EM charging interface socket, and allows access to the connector-face receiving opening for example only on the basis of a release, e.g. by specifying the method of payment and inputting credit card details, for example. Only when it has been established that the user is authorized to use the EM charging interface socket is the latch of the closure device released and the cover springs into the open position in this particular case.

On an inner edge pointing towards the collar, the latch holder may comprise a concave portion that is directed away from the collar and is designed such that the locking pin of the EM charging plug can be guided between the collar and the latch holder, in particular if the latch holder is mounted on the top of the EM charging interface socket.

In a particularly preferred embodiment of the invention, the base portion comprising the holder mounting holes and the mounting tabs of the bearing holder is designed to be identical to the base portion of the latch holder. In other words, in this embodiment the base portion is a common cover holder part in which either a cover or a latch can be supported. This design as a common part can further reduce the costs for production and storage of the closure device.

The electromobility charging interface socket is in particular designed to be compatible with SAE J1772/IEC 62196-2, GB/T-20234.2 and/or IEC 62196-3.

According to the invention, a modular closure device is also designed for an EM charging interface socket, for example for retrofitting a closure thereto.

The modular closure device comprises the bearing holder that can be arranged on the front panel of the socket housing of the EM charging interface socket beside the connector-face receiving opening, the bearing holder comprising the base portion extending along the front panel and in parallel with the front panel, the two holder mounting holes arranged in the base portion for detachably mounting the bearing holder on the socket housing, the two mounting tabs arranged on the base portion and the bearing mounted in the mounting tabs for supporting the cover.

The two holder mounting holes are arranged so as to line up with two mounting holes on the socket housing, such that the holder mounting holes overlap with the mounting holes when the bearing holder is arranged on the front panel and beside the connector-face receiving opening. Furthermore, the closure device comprises a cover that is supported in the bearing of the bearing holder and closes the connector-face receiving opening when shut.

Furthermore, the modular closure device may also comprise the latch holder that can be arranged on the front panel of the socket housing beside the connector-face receiving opening, the latch holder comprising the base portion extending along the front panel and in parallel with the front panel, the two holder mounting holes arranged in the base portion for detachably mounting the latch holder on the socket housing, the two mounting tabs arranged on the base portion and the latch that engages in the two mounting tabs for latching the cover when said cover is closed. In other words, the modular closure device constitutes a retrofitting solution for retrofitting existing EM charging interface sockets with a closure device as explained above.

The invention is explained in greater detail in the following on the basis of embodiments and with reference to the drawings, with identical and similar elements being provided with the same reference signs in some cases and it being possible for the features of the various embodiments to be combined with one another.

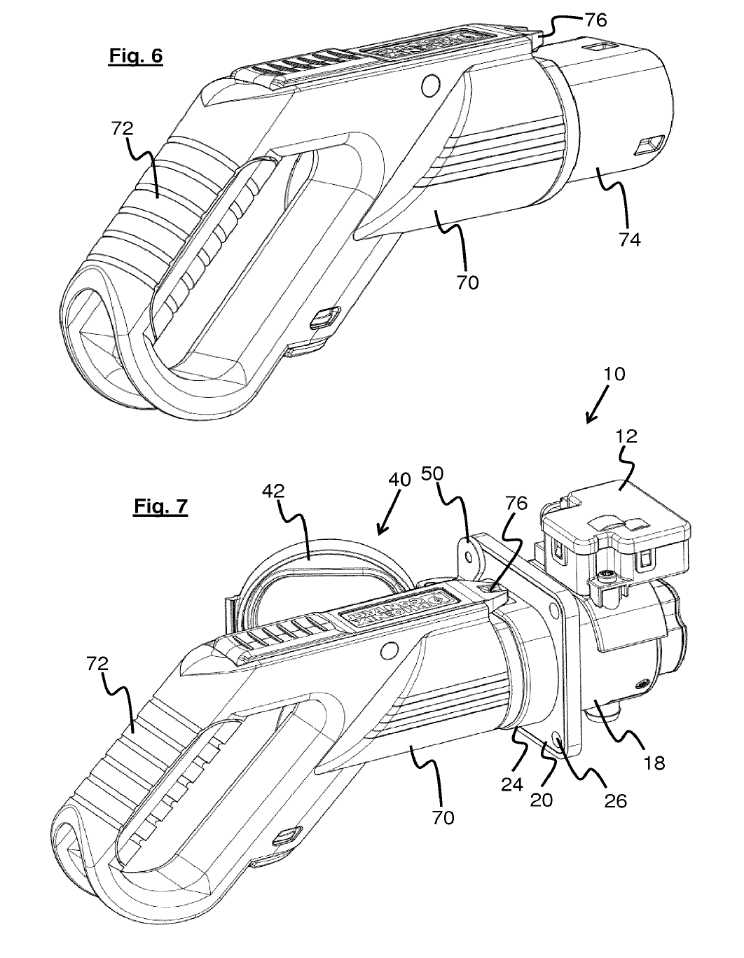

FIG. 1 is a front view of an EM charging interface socket 10 comprising a front panel 20 and a connector-face receiving opening 22. Around the connector-face receiving opening 22, a collar 24 projects from the front panel 20 perpendicularly to the front panel 20. A connector face 30 comprising seven contacts 32 is inserted into the connector-face receiving opening 22 such that the contacts 32 can be inserted from the front of the EM charging interface socket, in particular by means of an EM charging plug; cf. e.g. FIG. 6. The connector face 30 projects into a power outlet 18 which is arranged in the rear region of the EM charging interface socket 10 and provides protection from electrical contact for the connector face 30.

In this embodiment, the front panel 20 comprises four mounting holes 26 for mounting the EM charging interface socket 10 on the EM charging station by means of mounting means, in particular screws, guided through the mounting holes 26.

A bearing holder 50 of a closure device 40 is arranged on the left-hand side of the front panel 20 such that the two holder mounting holes 52 arranged in the base portion 51 are flush with two of the mounting holes 26. The mounting means for mounting the EM charging interface socket 10 can now be simultaneously inserted through the holder mounting holes 52 and the mounting holes 26 in a simple manner, such that the bearing holder 50 can be mounted on the front panel 20 of the EM charging interface socket 10 and the EM charging interface socket 10 can be mounted on the charging station using the same mounting means.

The base portion 51 comprises a lateral narrowed portion directed away from the collar 24 in the central region 54, by means of which narrowed portion the base portion 51 is further away from the collar 24 in the central region 54.

In FIG. 1, two mounting tabs 56, 57 are also arranged on the base portion 51 for mounting a bearing 46 for supporting the cover 42.

In this embodiment, the cover 42 comprises a sealing collar 44, which presses on the collar 24 when said cover is closed and provides air-tight and/or dust-resistant and/or waterproof sealing in the connector-face receiving opening in conjunction with the collar 24.

The collar 24 lastly comprises a locking hole 28 on the top, in which a locking pin (cf. FIG. 6) of the EM charging plug 70 (cf. FIG. 6) can be inserted and locked.

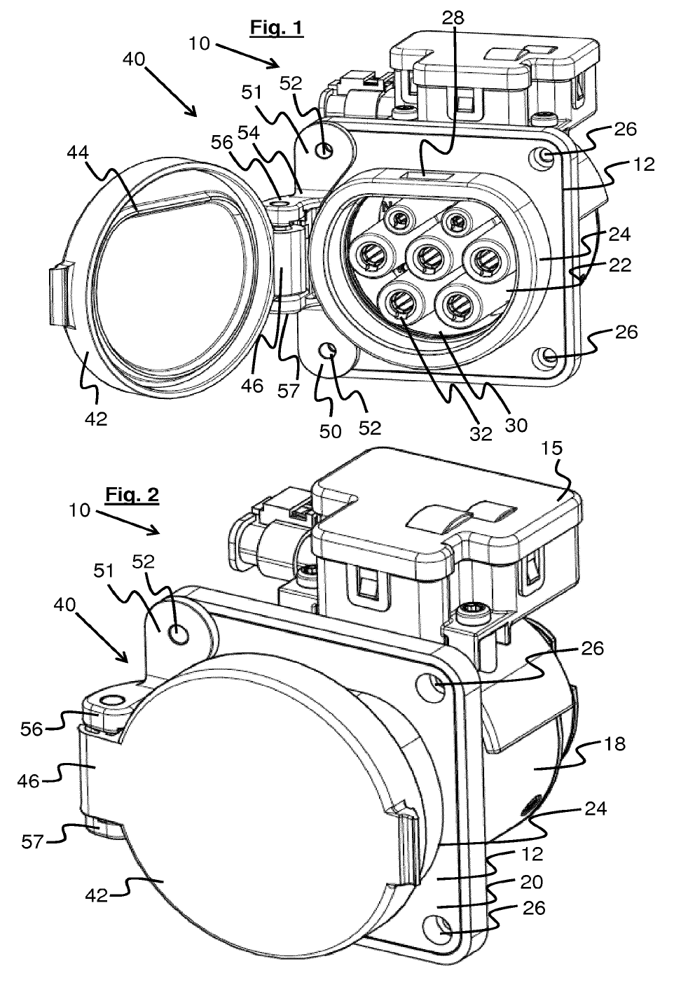

FIG. 2 shows an EM charging interface socket 10 in which the cover 42 of the closure device 40 is closed, and thus the connector-face insertion opening is closed by the cover 42. The cover 42 has a larger diameter than the collar 24 and thus laterally projects over the collar 24. This improves the sealing.

In the rear region, the EM charging interface socket 10 comprises a power outlet 18 that houses the connector face 30 (cf. FIG. 1) and the contacts 32, and provides an internal connection option for connecting the contacts 32 to the EM charging station. A contact guide 15 to which a contact plug of the EM charging station 80 (cf. FIG. 24) can be attached, for example, is arranged on the top of the power outlet 18, such that preferably no further wiring has to be guided through to the EM charging station 80 when attaching the EM charging interface socket 10, but instead a plug is merely inserted into the socket housing 12.

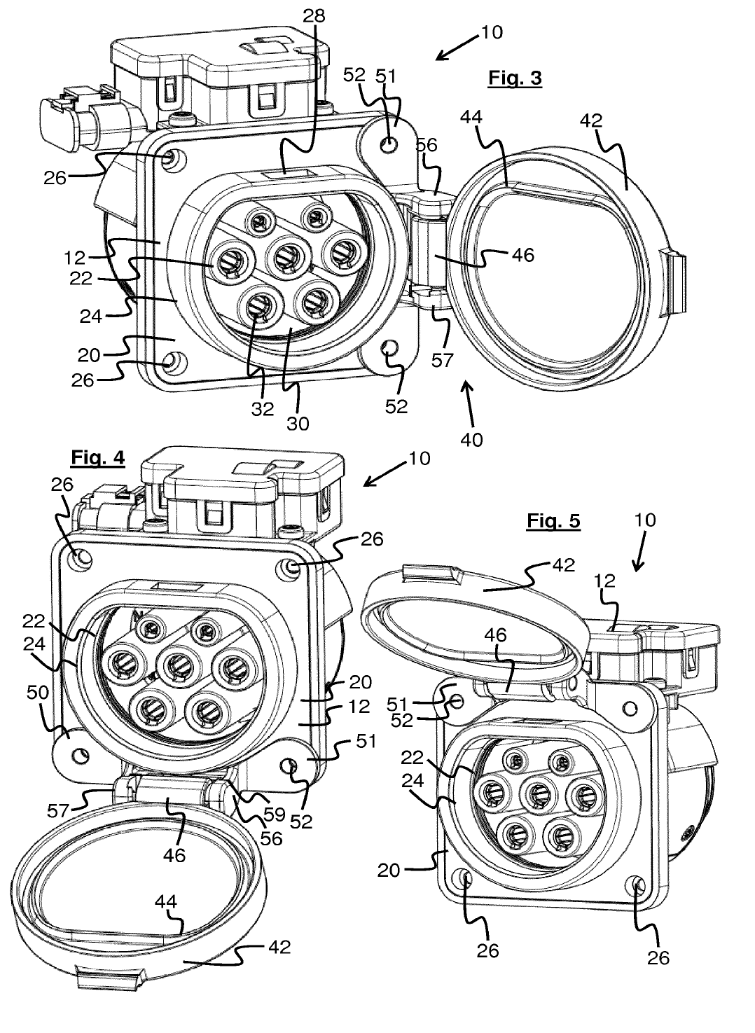

FIG. 3 shows an EM charging interface socket 10 comprising a closure device 40 arranged on the right. The cover 42 is supported in the bearing 46 and can completely close the connector-face receiving opening 22 when shut. The base portion 51 of the bearing holder 50 is arranged beside the collar 24 such that the two holder mounting holes 52 come to be flush with the mounting holes 26 in the EM charging interface socket 10.

FIG. 4 shows an EM charging interface socket 10 comprising a closure device 40 arranged at the bottom. Once again, the base portion 51 is arranged such that the two holder mounting holes 52 come to be flush with two of the mounting holes 26. The view in FIG. 4 shows a collar-side narrowed portion or a concave portion 59 of the two mounting tabs 56, 57 directed away from the collar 24. Owing to the particular shape of the bearing holder 50 having the concave portion 59 of the mounting tabs 56, 57, an additional space is created between the collar 24 and the bearing 46.

FIG. 5 shows a closure device 40 arranged at the top in which the cover 42 is pivoted upwards and thus is open. The bearing holder 50 is now arranged close to the locking hole 28, such that the locking pin has to pass under the bearing holder 50 when the EM charging interface socket 10 is connected to the EM charging plug in order to engage in the locking hole 28. In order to increase the space available for the connection between the EM charging plug and the EM charging interface socket 10, the mounting tabs 56, 57 comprise the collar-side concave portion 59. In other words, the bearing holder 50 of the closure device 40 provided with the collar-side concave portion 59 can also be arranged on the top of the EM charging interface socket 10, and still allows the locking pin of the EM charging plug to latch to the locking hole 28.

When FIGS. 1 to 5 are considered together, the versatility of the closure device 40 that allows the cover 42 to be arranged on all four sides of the EM charging interface socket 10 shown in the drawings is clear to see. It is also clear from considering FIGS. 1 to 5 together that it ultimately does not come down to the precise design of the EM charging interface socket 10 specifically shown in the drawings, but rather the equal spacing of the mounting holes 26, according to the invention, in conjunction with the specific design of the closure device 40 makes this variability possible. In addition, other electromobility charging interfaces, as specified for example in the SAE J1772/IEC 62196-2, GB/T-20234.2 or IEC 62196-3 standards, can be modified in terms of design and under the instruction of the present invention such that a modular closure device 40 can be attached to the relevant EM charging interface socket 10 as desired.

FIG. 6 shows an EM charging plug 70 for insertion into the EM charging interface socket 10. For improved handling, the EM charging plug 70 comprises a handle 72 that has an optionally rubberized and robust surface. A charging-plug collar 74 provides protection from electrical contact from the charging-plug contacts housed in the charging-plug collar 74. When the EM charging plug 70 is inserted into the EM charging interface socket 10, the charging-plug collar 74 engages in the collar 24 so as to be flush, such that the risk of touching one of the contacts is minimized and it is ensured that the inserted assembly is sealed as tightly as possible at the same time. The locking pin 76 that can engage in the locking hole 28 is arranged at the top.

FIG. 7 shows the assembly of the EM charging plug 70 and the EM charging interface socket 10 when joined together, with the locking pin 76 engaging in the locking hole 28. The closure device 40 is arranged on the left and is open.

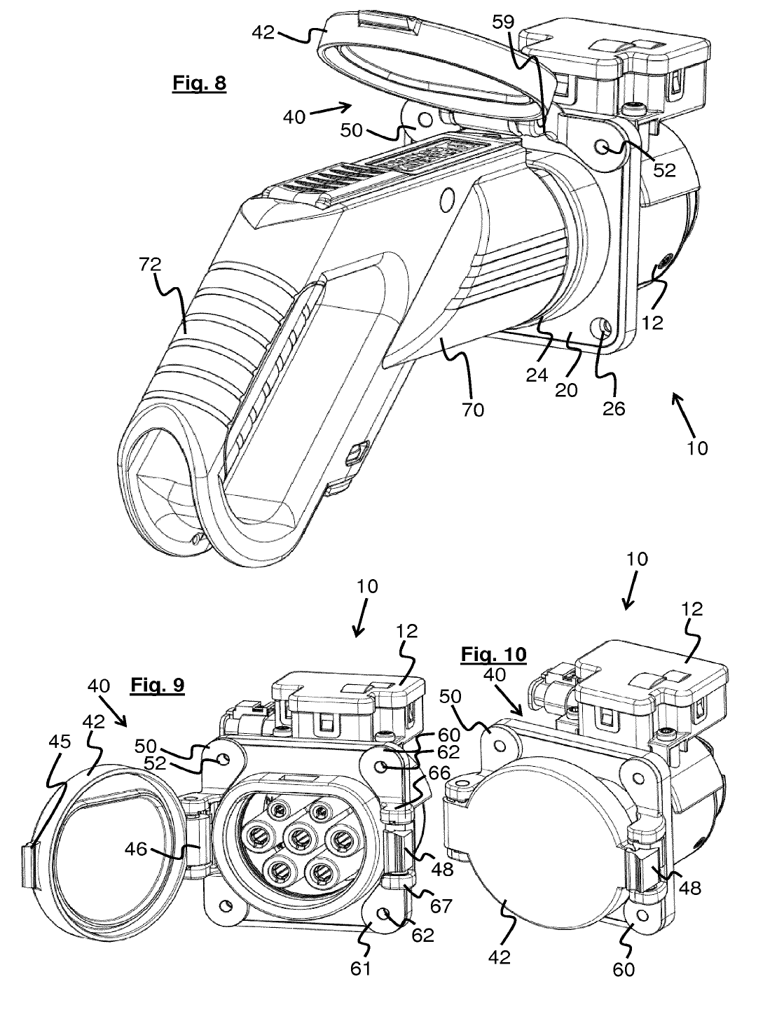

FIG. 8 shows the assembly of the EM charging plug 70 and the EM charging interface socket 10 when joined together, with the closure device 40 arranged at the top. The locking pin 76 is below and close to the bearing 46 in which the cover 42 is supported. The concave portion 59 of the mounting tabs 56, 57 creates additional space for inserting the locking pin 76 between the bearing 46 and the collar 24. In other words, the specific design of the mounting tabs 56, 57 allows the closure device 40 to be arranged at the top of the EM charging interface socket 10, with the locking pin 76 of the EM charging plug 70 latching into the locking hole 28 at the top.

FIG. 9 shows another configuration of the closure device 40 arranged on the front face of the front panel 20 of the EM charging interface socket 10. Based on the spatial arrangement relative to the connector-face receiving opening 22, a latch holder 60 is arranged opposite the bearing holder 50 attached on the left. In other words, two parts of the closure device 40, namely the bearing holder 50 and the latch holder 60, are arranged opposite one another on the front panel 20. The latch holder 60 comprises a base portion 61 and two holder mounting holes 62 made in the base portion 61 for mounting the latch holder 60 on the EM charging interface socket 10. The latch holder 60 comprises a latch 48 for latching the cover 42 when it is closed. The cover 42 comprises a latching lug 45 that fits into the latch 48 and can engage in the latch 48 when the cover 42 is closed. The latch 48 preferably comprises an actuating portion 49 on the front. The actuating portion 49 can for example be manually operated by a tangential force, i.e. a force in the perpendicular direction away from collar 24, being exerted on the actuating portion 49 and by the latch 48, which is integrally formed with the actuating portion 49 in the present simple example, releasing the cover 42. In other words, in this example the latch is rotatably mounted on a pin 47 such that the cover 42 can cause the latch 48 to rotate about the pin 47 when transitioning into the closed position 42 if the latching lug 45 presses on the latch 48. Preferably, the latch 48 is equipped with a return spring such that the latch 48 automatically returns to the starting position after passing the latching lug 45. Even for manual operation, i.e. when opening the latch 48 to release the cover 42, the return force of the return spring can be overcome by means of manual force and the latch 48 can be brought into a release position in order to release the cover 42. Once the cover 42 is released from the latch 48 and the latch 48 is freed, the latch 48 automatically returns to the starting position by means of the return spring.

In the example in FIG. 9, the base portions 51, 61 are designed as common parts together with the holder mounting holes 52, 62 and the mounting tabs 56, 57, 66, 67. In other words, the base portion 51 of the bearing holder 50 and the base portion 61 of the latch holder 60 are interchangeable.

The bearing holder 50 is separate from the latch holder 60, meaning that these are two separate components. The use of the two separate components of the bearing holder 50 and the latch holder 60 in the closure device 40 allows the components to be used in a modular manner depending on whether the operator of an EM charging station 80 wants the cover 42 to comprise the bearing holder 50 and the latch holder 60, or whether they want the cover 42 to only comprise the bearing holder 50. As can be seen in the example in FIG. 9, separating the bearing holder 50 from the latch holder 60 also leaves a gap between the two components 50, 60, such that, if necessary, tightly fitting EM charging plugs 70 can be inserted into the EM charging interface socket 10, despite the closure device 40 having been attached, if the closure device 40 is mounted in the appropriate position, e.g. to the left as shown in the example in FIG. 9.

The modular interchangeability of the bearing holder 50 and the latch holder 60 also allows cost savings to be made during manufacture, which can be directly passed on to customers, and therefore a tailored product can be purchased and lower prices can be achieved.

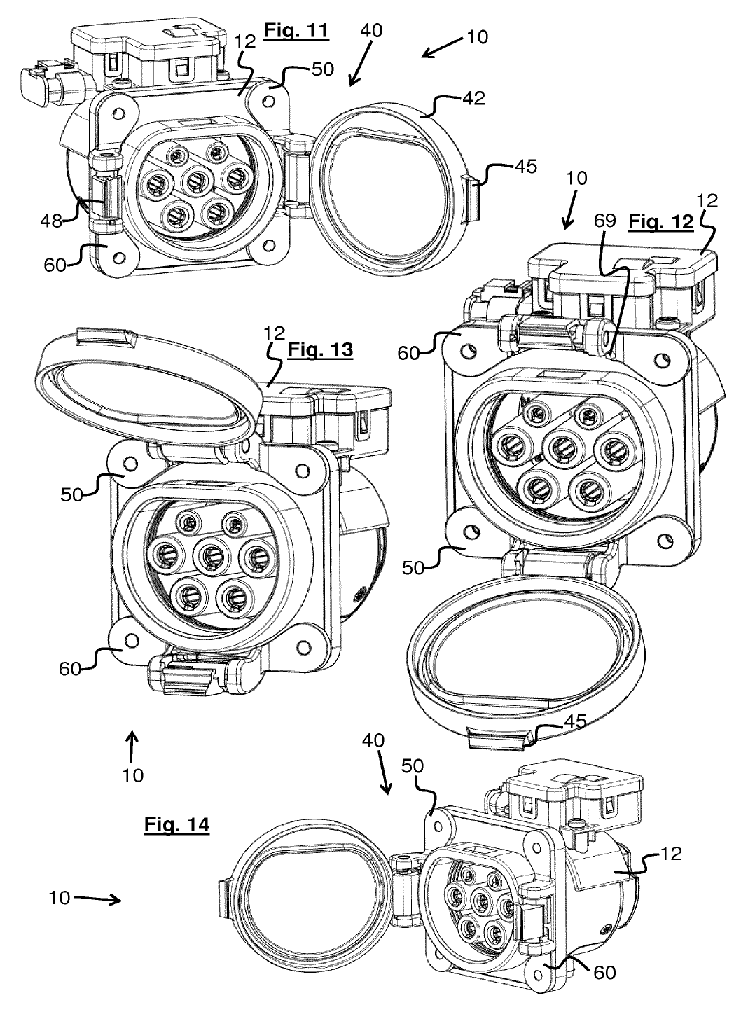

In the embodiment in FIG. 10, the cover 42 is in the closed state, in which it is held by the latch 48 of the latch holder 60. A return spring is therefore preferably arranged in the bearing 46 of the bearing holder 50, which spring pushes open the cover once the latch 48 releases the latching lug 45 of the cover 42, for example by the actuating portion 49 being manually actuated.

FIG. 11 shows an embodiment with the bearing holder 50 arranged on the right and the latch holder 60 arranged on the left.

FIG. 12 shows a bearing holder 50 arranged at the bottom and a latch holder 60 arranged at the top. For the latch holder 60, too, the concave portions 69 of the mounting tabs 66, 67 allow the locking pin 76 to be inserted between the latch holder 60 and the collar 24.

FIG. 13 shows the reverse, with the bearing holder 50 arranged at the top and the latch holder 60 arranged at the bottom.

FIG. 14 lastly shows a bearing holder 50 arranged on the left and a latch holder 60 arranged on the right.

FIG. 15 shows the EM charging plug 70 inserted into the EM charging interface socket 10 and the cover 42 when open. This embodiment also shows a hook-shaped design of the front edge of the latch 48, which can engage in a complementary groove 47 in the latching lug 45.

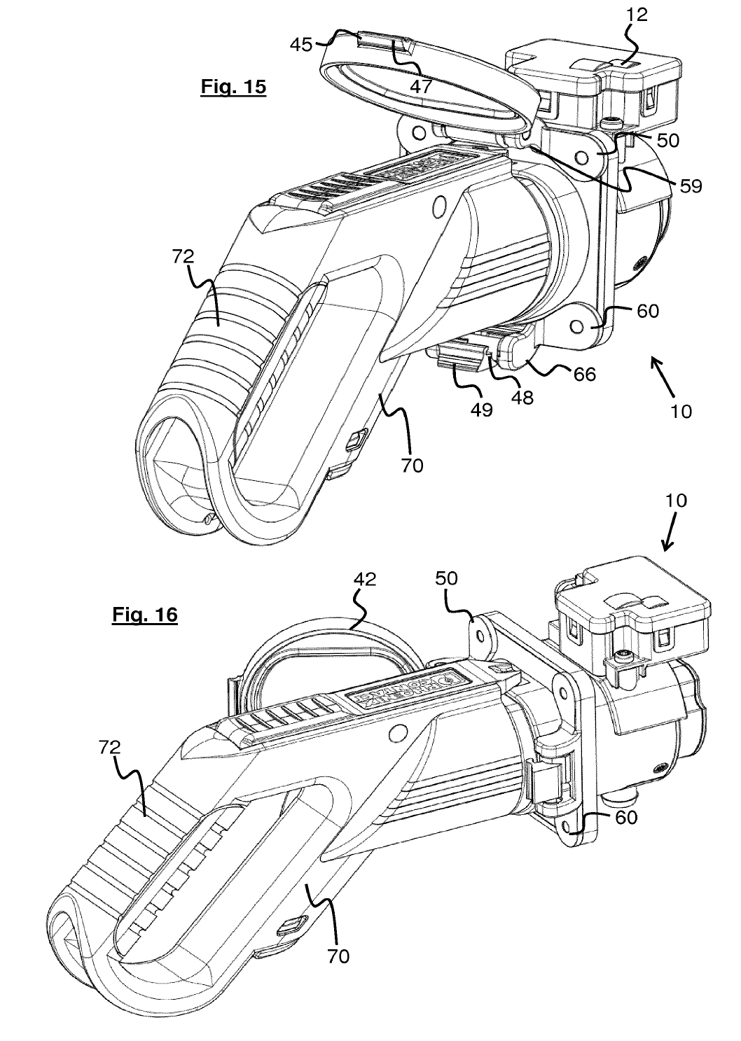

FIG. 16 shows a bearing holder 50 arranged on the left and a latch holder 60 arranged on the right. In this arrangement, it is particularly easy to insert the EM charging plug 70 into the EM charging interface socket 10.

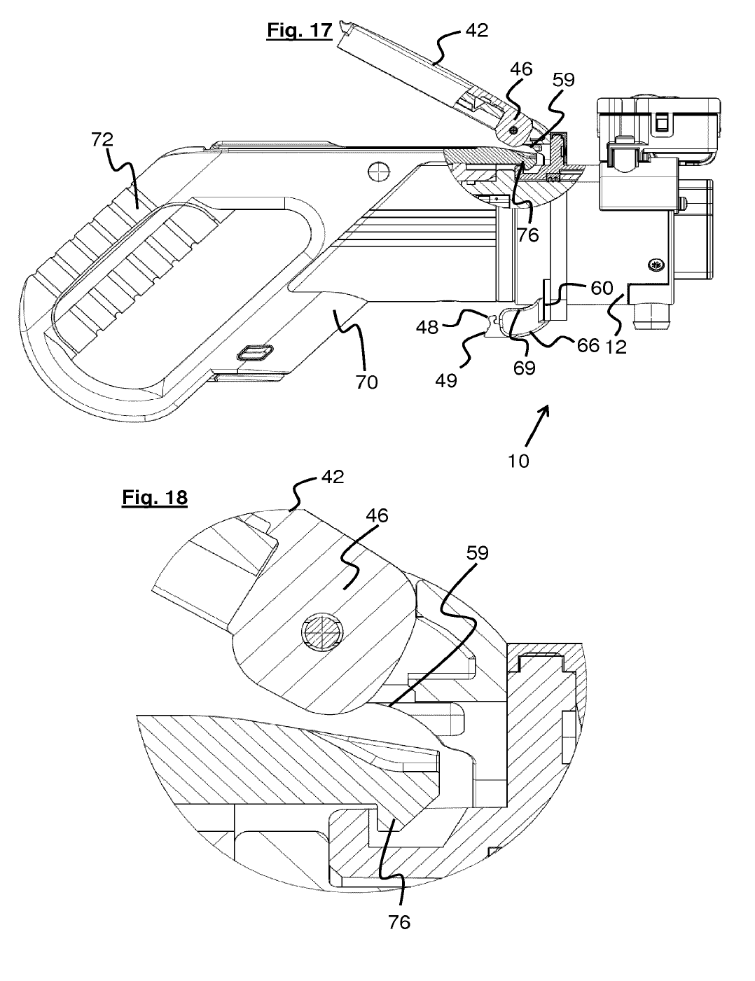

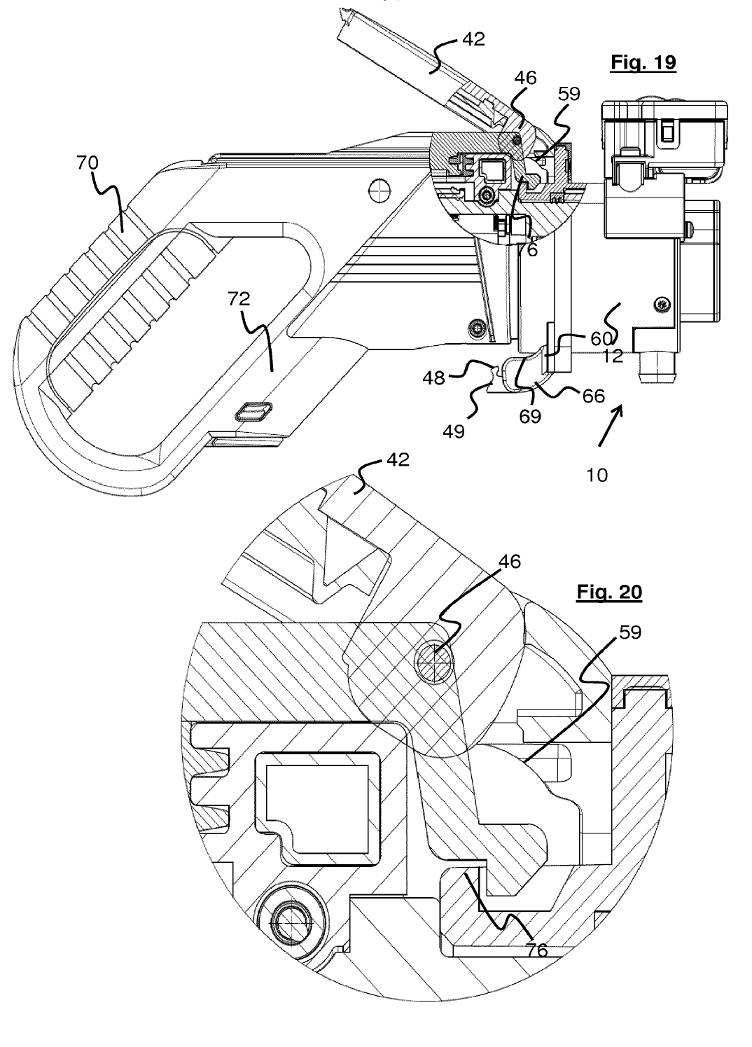

FIG. 17 is a partial sectional view of the EM charging plug 70 inserted into the EM charging interface socket 10. The locking pin 76 latched in the locking hole 28 can reliably reach the latching position due to the concave portions 59.

FIG. 18 is an enlarged detail of FIG. 17, in which the shape of the concave portion 59 which provides sufficient space for inserting the locking pin 76 into the locking hole 28 can be more clearly seen. The electromobility charging plug 70 can also be specially designed such that it comprises surfaces that are complementary to or fit into the concave portion 59 and such that this also makes it easier for the latching position to be reached.

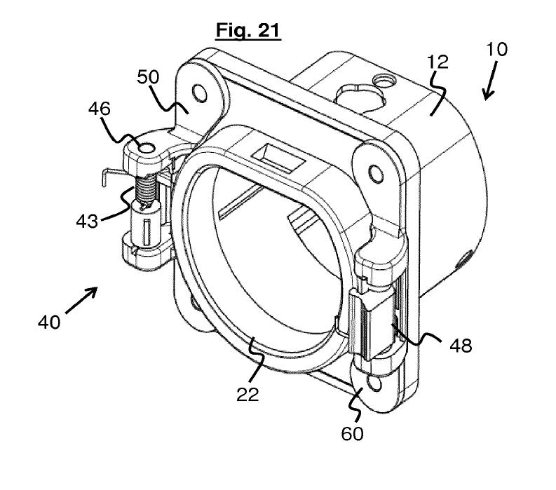

FIG. 19 shows an embodiment of a charging plug 70 that cannot be inserted when the bearing holder 50 is arranged at the top because an upper corner of the charging plug 70 overlaps with the bearing 46. The arrangement in FIG. 19 shows by way of example that the development of a new charging plug 70, as shown previously in FIGS. 17 and 18, for example, also improves the ability of the bearing holder 50 to be freely arranged on any side of the EM charging interface socket 10. In an EM charging interface socket in which various charging plugs 70 which may not fit are used, the bearing holder 50 can be arranged on the left, on the right or at the bottom as appropriate, such that it is still possible to close the EM charging interface socket 10 by means of the cover 42.

It is however also possible to provide an EM charging plug 70 that can be advantageously inserted into the EM charging interface socket 10 past the concave portion 59 and to provide, on the opposite end of the EM interface connecting cable 90, an EM charging plug 70a that differs therefrom and that cannot be inserted into the EM charging interface socket 10 of the EM charging station 80.

FIG. 20 is a view of a detail from FIG. 19 which shows the overlap between the bearing 46 and a projection of the locking pin 76.

FIG. 21 shows an embodiment of the modular closure device 40 according to the invention having a bearing holder 50, a latch holder 60 and a latch 48, the cover 42 not being shown to improve visibility. A return spring 43 arranged in the bearing 47 brings about a force that pushes the cover 42 open, such that the cover 42 automatically moves into the open state when the latch 48 releases the cover.

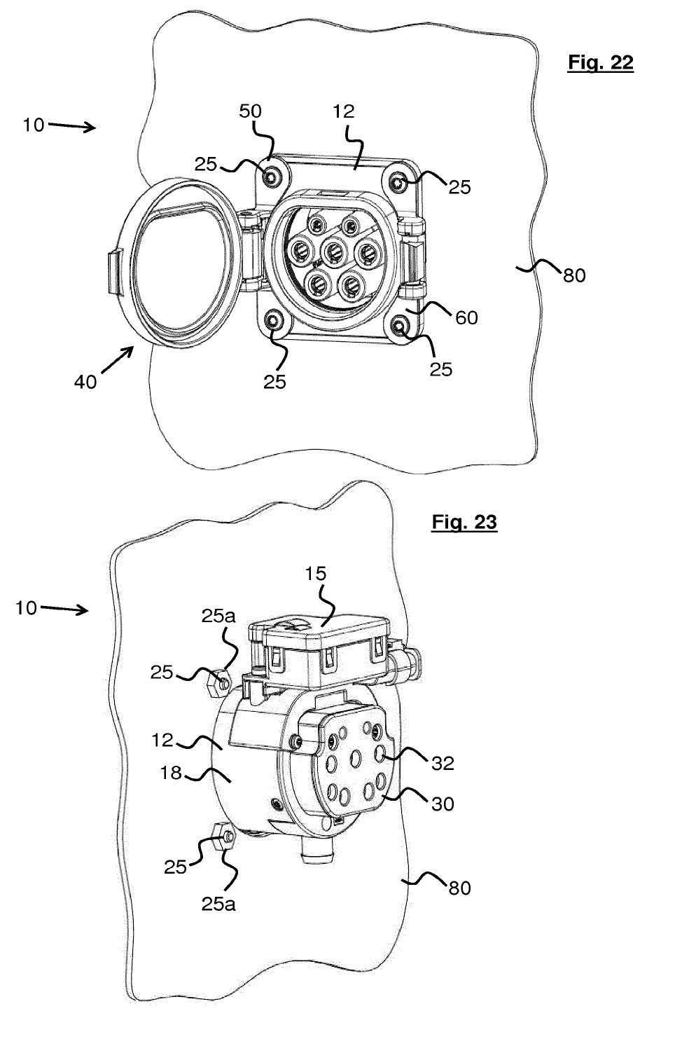

FIG. 22 shows an EM charging interface socket 10 screwed to an EM charging station 80 by means of mounting means 25, i.e. screws 25. The screws 25 are each simultaneously screwed through a mounting hole 26 and a holder mounting hole 52 or a holder mounting hole 62, such that a mounting means 25 both mounts the EM charging interface socket 10 on the EM charging station 80 and mounts the closure device 40 on the EM charging interface socket 10.

FIG. 23 is a rear view of an EM charging interface socket 10 screwed to an EM charging station 80 by means of mounting means 25. The mounting means 25, i.e. screws 25 in this example, engage in mounting means 25a that can be paired with the mounting means 25. In this example, these are nuts 25a which are fastened to the charging station 80 and in which mounting screws 25 engage through the holder mounting holes 52 and 62 and through the mounting holes 26 from outside.

FIG. 24 shows an assembly of an EM charging interface socket 10 screwed to an EM charging station 80, an EM charging plug 70 that can be inserted therein and an EM vehicle 95 to be charged.

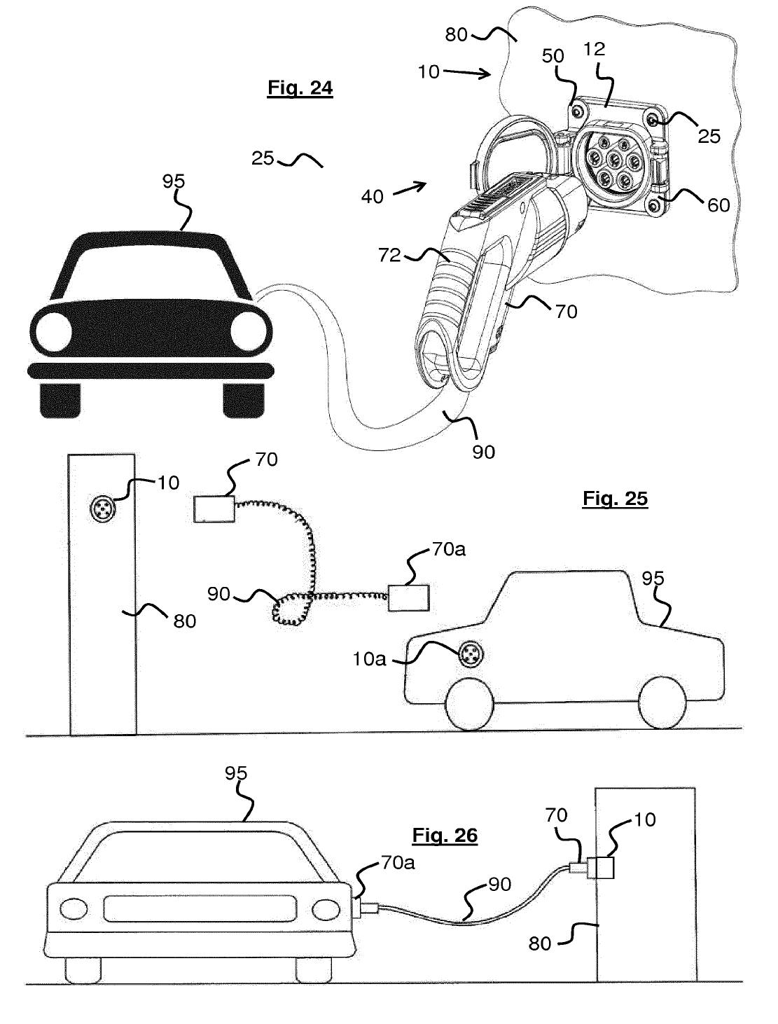

FIG. 25 shows another assembly of an EM charging interface socket 10 arranged on an EM charging station 80, an EM charging plug 70 that can be inserted therein and an EM vehicle 95 to be charged comprising an EM charging interface socket 10a into which an EM charging plug 70a can be inserted. In this example, the EM vehicle 95 accordingly also comprises an EM charging interface socket 10a that can also be suitably designed so that a closure device 40 according to the invention can be attached thereto.

FIG. 26 shows yet another assembly of an EM charging interface socket 10 attached to an EM charging station 80, an EM charging plug 70 inserted into the connector face 30 of the EM charging interface socket 10 and an EM vehicle 95 to be charged.

It is clear to a person skilled in the art that the above-described embodiments should be understood as examples, and that the invention is not restricted thereto but rather can be varied in many ways without departing from the scope of protection of the claims. It is also clear that the features also individually specify essential parts of the invention, even if they are jointly described together with other features, irrespective of whether they are disclosed in the description, the claims, the drawings or elsewhere.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 electromobility charging interface socket
12 socket housing
15 contact guide
18 power outlet
20 front panel
22 connector-face receiving opening
24 collar
25 mounting means
25a additional mounting means that can be paired with the mounting means 25
26 mounting holes
28 locking hole
30 connector face
32 contact
40 closure device
42 cover
43 damper or return spring
44 sealing collar
45 latching lug
46 bearing
47 pin
48 latch
49 actuating portion
50 bearing holder
51 base portion
52 holder mounting holes
54 central region of the base portion
56 mounting tab
57 mounting tab
59 concave portion
60 latch holder
61 base portion
62 holder mounting hole
66 mounting tab
67 mounting tab
69 concave portion
70 electromobility charging plug
70a electromobility charging plug
72 handle
74 charging-plug collar
76 locking pin
80 electromobility charging station
90 EM interface connecting cable
95 EM vehicle

1. An electromobility charging interface socket for connecting an electromobility charging station to an electromobility vehicle, comprising:
a socket housing comprising a front panel having a connector-face receiving opening and a rear face having a power outlet;
an inner part that is arranged in the power outlet and comprises a connector face having a plurality of electrical contacts;
a collar that is arranged on the front panel of the socket housing, surrounds the connector-face receiving opening, and projects from the front panel;
mounting holes arranged on the front panel of the socket housing beside the connector-face receiving opening, by which holes the electromobility charging interface socket is configured to be mounted on the electromobility charging station; and
a closure device that is arranged on the front panel of the socket housing and is separate from the socket housing,
wherein the closure device comprises a bearing holder,
wherein the bearing holder of the closure device comprises a base portion extending along the front panel and in parallel with the front panel, two holder mounting holes arranged in the base portion for detachably mounting the bearing holder on the socket housing, a mounting tab arranged on the base portion, and a bearing supported in the mounting tab for supporting a cover, and
wherein the two holder mounting holes are arranged so as to line up with two of the mounting holes on the socket housing, such that the holder mounting holes overlap with the mounting holes when the bearing holder is arranged on the front panel and beside the connector-face receiving opening.

2. The electromobility charging interface socket according to claim 1,
wherein the mounting tab of the bearing holder is arranged between the holder mounting holes.

3. The electromobility charging interface socket according to claim 1,
further comprising a second mounting tab, wherein the bearing is supported between the mounting tabs.

4. The electromobility charging interface socket according to claim 1,
wherein the mounting holes are a plurality of, in particular four or more than four, mounting holes arranged on the front panel of the socket housing around the connector-face receiving opening at equal spacing from one another, and
wherein the bearing holder is configured to be arranged in two adjacent mounting holes on one of the, in particular four, sides of the socket housing, and is configured to be detachably connected to the socket housing.

5. The electromobility charging interface socket according to claim 1, further
comprising a cover that is supported in the bearing of the bearing holder and is configured to close the connector-face receiving opening when shut,
wherein a damper, in particular a spring for slowly opening or closing the cover, is arranged on the bearing of the bearing holder.

6. The electromobility charging interface socket according to claim 1,
wherein the collar surrounding the connector-face receiving opening comprises a locking hole on a top thereof, in which a locking pin of the electromobility charging plug is configured to engage in order to hold the electromobility charging plug in the electromobility charging interface socket, and
wherein, on an inner edge pointing towards the connector-face receiving opening, the bearing holder comprises a concave portion that is directed away from the collar and is configured such that the locking pin of the electromobility charging plug is guided between the collar and the bearing holder, in particular if the bearing holder is mounted on the top of the electromobility charging interface socket.

7. The electromobility charging interface socket according to claim 1,
wherein the closure device further comprises a latch holder arranged opposite the bearing holder, and
wherein the latch holder comprises a base portion extending along the front panel and in parallel with the front panel, two holder mounting holes arranged in the base portion for detachably mounting the latch holder on the socket housing, two mounting tabs arranged on the base portion and a latch configured to engage in the two mounting tabs for latching the cover when said cover is closed.

8. The electromobility charging interface socket according to claim 7,
wherein the collar surrounding the connector-face receiving opening comprises a locking hole on a top thereof, in which a locking pin of the electromobility charging plug is configured to engage in order to hold the electromobility charging plug in the electromobility charging interface socket, and
wherein, on an inner edge pointing towards the collar, the latch holder comprises a concave portion that is directed away from the collar and is configured such that the locking pin of the electromobility charging plug is guided between the collar and the latch holder, in particular if the latch holder is mounted on the top of the electromobility charging interface socket.

9. The electromobility charging interface socket according to claim 1, wherein the base portion comprising the holder mounting holes and the mounting tabs of the bearing holder is configured to be identical to the base portion of the latch holder.

10. The electromobility charging interface socket according to claim 1, wherein the electromobility charging interface socket is configured to be compatible with SAE J1772/IEC 62196-2, GB/T-20234.2, or IEC 62196-3.

11. A modular closure device for an electromobility charging interface socket, comprising:
a bearing holder configured to be arranged on a front panel of a socket housing of the electromobility charging interface socket beside a connector-face receiving opening,
the bearing holder comprising a base portion extending along the front panel and in parallel with the front panel, two holder mounting holes arranged in the base portion for detachably mounting the bearing holder on the socket housing, a mounting tab arranged on the base portion, and a bearing supported in the mounting tab for supporting a cover,
the two holder mounting holes being arranged so as to line up with two mounting holes in the socket housing, such that the holder mounting holes overlap with the mounting holes when the bearing holder is arranged on the front panel and beside the connector-face receiving opening; and
a cover that is supported in the bearing of the bearing holder and is configured to close the connector-face receiving opening when shut.

12. The module closure device according to claim 11, further comprising
a latch holder configured to be arranged on the front panel of the socket housing beside the connector-face receiving opening,
wherein the latch holder comprises a base portion extending along the front panel and in parallel with the front panel, two holder mounting holes arranged in the base portion for detachably mounting the latch holder on the socket housing, a mounting tab arranged on the base portion, and a latch configured to engage in the mounting tab for latching the cover when said cover is closed.

13. The module closure device according to claim 11,
wherein the bearing holder is arranged so as to be opposite the latch holder in relation to the connector-face receiving opening, and
wherein the bearing holder and the latch holder that is separate from the bearing holder are each arranged so as to be individually detachably mounted on the front panel.
